(19) United States
(12) Patent Application Publication
(10) Pub. No.: US 2017/0242241 A1
(43) Pub. Date: Aug. 24, 2017

(54) WAVELENGTH CONVERSION ELEMENT, LIGHT SOURCE DEVICE, AND PROJECTOR

(71) Applicant: SEIKO EPSON CORPORATION, Tokyo (JP)

(72) Inventor: Shigeo NOJIMA, Azumino-shi (JP)

(73) Assignee: SEIKO EPSON CORPORATION, Tokyo (JP)

(21) Appl. No.: 15/437,870

(22) Filed: Feb. 21, 2017

(30) Foreign Application Priority Data
Feb. 24, 2016 (JP) 2016-033137

(51) Int. Cl. G02B 26/00; G03B 21/20

(52) U.S. Cl. CPC G02B 26/008; G03B 21/204

(57) ABSTRACT

The disclosure relates to a wavelength conversion element including: a substrate rotatable around an axis of rotation; and a phosphor layer, wherein the substrate includes a first region on the inner circumferential side of the substrate and a second region provided closer to the outer circumferential side than the first region and thinner than the first region, and the phosphor layer is provided in the first region.

### BACKGROUND

1. Technical Field

The present invention relates to a wavelength conversion element, a light source device, and a projector.

2. Related Art

As a light source device for a projector, a light source device that irradiates a phosphor layer provided on a phosphor wheel with excitation light emitted from a light-emitting element and uses, as image light, fluorescence emitted from the phosphor layer has been known in the related art (e.g., see JP-A-2010-256457).

Since an increase in the temperature of the phosphor layer reduces the efficiency in conversion to fluorescence, it is important for obtaining high-output fluorescence to sufficiently suppress the temperature increase of the phosphor layer. In the above light source device, therefore, the temperature increase of the phosphor layer is suppressed by using glass as a binder of the phosphor layer.

However, since glass is highly brittle, the phosphor layer may be broken during the assembly of the phosphor wheel.

### SUMMARY

An advantage of some aspects of the invention is to provide a wavelength conversion element, a light source device, and a projector in each of which a phosphor layer is less likely to break during assembly.

A first aspect of the invention provides a wavelength conversion element including: a substrate rotatable around an axis of rotation; and a phosphor layer, wherein the substrate includes a first region on the inner circumferential side of the substrate and a second region provided closer to the outer circumferential side than the first region and thinner than the first region, and the phosphor layer is provided in the first region.

According to the wavelength conversion element according to the first aspect, since the region of the substrate where the phosphor layer is provided is thick, the support portion of the substrate for the phosphor layer is less likely to deform. With this configuration, the phosphor layer is less likely to break during the assembly of the wavelength conversion element.

In the first aspect, it is preferable that the phosphor layer has a ring shape, and that when a region of the substrate located inside the inner circumference of the phosphor layer is defined as a third region, the substrate is thicker in the third region than in the second region.

According to this configuration, when the phosphor layer has a ring shape, the third region where the phosphor layer is not provided is also thicker than the second region and therefore the substrate is less likely to deform.

In the first aspect, it is preferable that the substrate includes a first portion including a first surface and a second surface opposite the first surface, and a second portion, that the phosphor layer is provided on the first surface, and that the second portion is provided in the first region of the second surface.

According to this configuration, it is possible to simply and reliably realize a configuration in which the first region of the substrate where the phosphor layer is provided is thicker than the second region.

In the first aspect, it is preferable that the phosphor layer is formed of an inorganic material.

According to this configuration, the phosphor layer is excellent in heat-dissipating property, so that high luminous efficiency can be obtained. The above-described phosphor layer excellent in heat-dissipating property is highly brittle and likely to break. However, when the invention is applied, the phosphor layer is less likely to break as described above.

In the first aspect, it is more desirable that the phosphor layer is formed of a sintered body containing a phosphor.

By doing this, since the phosphor layer that is more excellent in heat resistance is included, higher luminous efficiency can be obtained.

A second aspect of the invention provides a light source device including: the wavelength conversion element according to the first aspect; a drive device that rotates the substrate around the axis of rotation; and a light-emitting element that emits excitation light to be incident on the phosphor layer.

According to the light source device according to the second aspect, since the wavelength conversion element less susceptible to poor luminescence due to the breakage of the phosphor layer is included, the light source device can stably emit light and has high reliability.

A third aspect of the invention provides a projector including: the light source device according to the second aspect; a light modulator that modulates, in response to image information, light from the light source device to thereby form image light; and a projection optical system that projects the image light.

According to the projector according to the third aspect, since the light source device having high reliability is included, the projector has high reliability.

### BRIEF DESCRIPTION OF THE DRAWINGS

The invention will be described with reference to the accompanying drawings, wherein like numbers reference like elements.

FIG. 1 is a top view showing an optical system of a projector according to a first embodiment.

FIG. 2 is an elevation view of a phosphor wheel according to the first embodiment.

FIG. 3 is a cross-sectional view taken along line B1-B1 of FIG. 2.

FIG. 4 is an elevation view of a phosphor wheel according to a second embodiment.

FIG. 5 is a cross-sectional view taken along line B2-B2 of FIG. 4.

FIG. 6 is an elevation view of a phosphor wheel according to a third embodiment.

FIG. 7 is a cross-sectional view taken along line B3-B3 of FIG. 6.

### DESCRIPTION OF EXEMPLARY EMBODIMENTS

Hereinafter, embodiments of the invention will be described in detail with reference to the drawings. In the drawings used in the following description, a characteristic portion may be shown in an enlarged manner, for convenience sake, to facilitate understanding thereof, and thus the dimension ratio and the like of each component are not always the same as actual ones.

### First Embodiment

A projector of a first embodiment is a projection-type image display device that displays a color video on a screen. The projector includes three liquid crystal light modulators corresponding to respective color lights: red light, green light, and blue light. The projector includes, as a light source of an illumination device, a semiconductor laser from which high-luminance, high-output light is obtained.

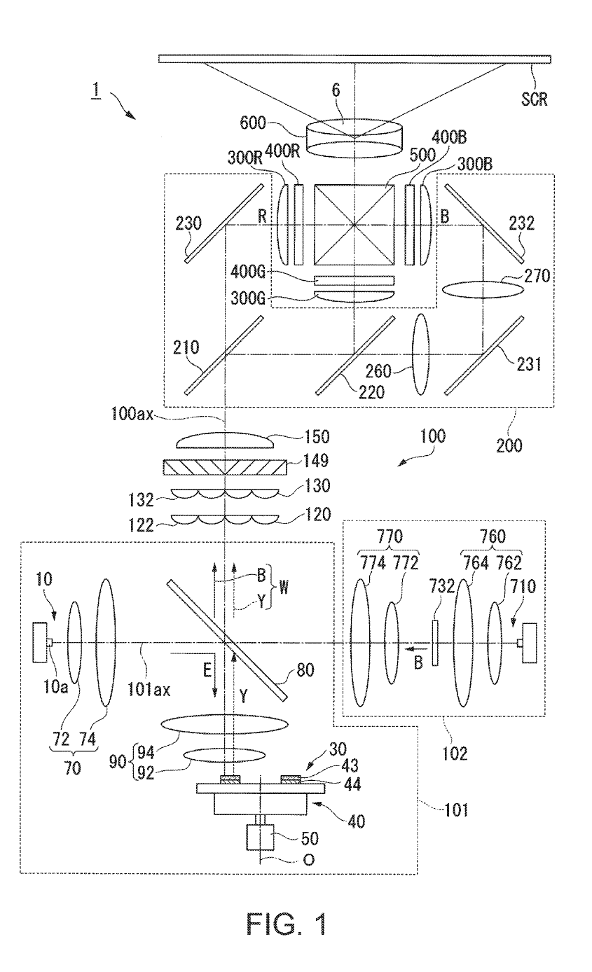

FIG. 1 is a top view showing an optical system of the projector according to the embodiment.

As shown in FIG. 1, the projector 1 includes an illumination device 100, a color separation and light guide optical system 200, liquid crystal light modulators 400R, 400G, and 400B, a cross dichroic prism 500, and a projection optical system 600.

The illumination device 100 includes a first light source device 101, a second light source device 102, a first lens array 120, a second lens array 130, a polarization conversion element 149, and a superimposing lens 150.

The first light source device 101 includes a first light source 10, a collimating optical system 70, a dichroic mirror 80, a collimating condenser optical system 90, a phosphor wheel 30, and a motor 50.

In the embodiment, the first light source device 101 corresponds to “light source device” in the appended claims, and the phosphor wheel 30 corresponds to “wavelength conversion element” in the appended claims.

The first light source 10 includes a semiconductor laser 10a that emits, as excitation light, blue light (emission intensity peak: approximately 445 nm) E formed of laser light. The first light source 10 may be formed of one semiconductor laser 10a, or may be formed of many semiconductor lasers 10a. For the first light source 10, a semiconductor laser that emits blue light at a wavelength of other than 445 nm (e.g., 460 nm) can also be used.

In the embodiment, the semiconductor laser 10a corresponds to “light-emitting element” in the appended claims, and the motor 50 corresponds to “drive device” in the appended claims.

In the embodiment, the first light source 10 is disposed such that the optical axis thereof is orthogonal to an illumination optical axis 100ax.

The collimating optical system 70 includes a first lens 72 and a second lens 74, and substantially collimates the light from the first light source 10. The first lens 72 and the second lens 74 are each formed of a convex lens.

The dichroic mirror 80 is disposed on the optical path from the collimating optical system. 70 to the collimating condenser optical system 90 so as to cross each of the optical axis 101ax of the first light source 10 and the illumination optical axis 100ax at an angle of 45°. The dichroic mirror 80 reflects blue light B and transmits yellow fluorescence Y including red light and green light.

The collimating condenser optical system 90 has the function of causing the excitation light E from the dichroic mirror 80 to be incident in a substantially concentrated state on a phosphor layer 43 of the phosphor wheel 30, and the function of substantially collimating the fluorescence Y emitted from the phosphor wheel 30. The collimating condenser optical system 90 includes a first lens 92 and a second lens 94. The first lens 92 and the second lens 94 are each formed of a convex lens.

The second light source device 102 includes a second light source 710, a condenser optical system 760, a scattering plate 732, and a collimating optical system 770.

The second light source 710 is formed of a semiconductor laser of the same kind as that of the first light source 10 of the first light source device 101.

The condenser optical system 760 includes a first lens 762 and a second lens 764. The condenser optical system 760 concentrates blue light from the second light source 710 in the vicinity of the scattering plate 732. The first lens 762 and the second lens 764 are each formed of a convex lens.

The scattering plate 732 scatters the blue light from the second light source 710 to convert the blue light to the blue light B having a light distribution similar to the light distribution of the fluorescence Y emitted from the phosphor wheel 30. As the scattering plate 732, for example, frosted glass formed of optical glass can be used.

The collimating optical system 770 includes a first lens 772 and a second lens 774, and substantially collimates the light from the scattering plate 732. The first lens 772 and the second lens 774 are each formed of a convex lens.

In the embodiment, the blue light B from the second light source device 102 is reflected by the dichroic mirror 80, and combined with the fluorescence Y emitted from the phosphor wheel 30 and transmitted through the dichroic mirror 80 to form white light W. The white light W is incident on the first lens array 120.

The first lens array 120 includes a plurality of first small lenses 122 for dividing the light from the dichroic mirror 80 into a plurality of partial luminous fluxes. The plurality of first small lenses 122 are arranged in a matrix in a plane orthogonal to the illumination optical axis 100ax.

The second lens array 130 includes a plurality of second small lenses 132 corresponding to the plurality of first small lenses 122 of the first lens array 120. The second lens array 130 forms, in conjunction with the superimposing lens 150, images of the first small lenses 122 of the first lens array 120 in the vicinities of the image forming regions of the liquid crystal light modulators 400R, 400G, and 400B. The plurality of second small lenses 132 are arranged in a matrix in a plane orthogonal to the illumination optical axis 100ax.

The polarization conversion element 149 converts each of the partial luminous fluxes divided by the first lens array 120 to linearly polarized light. The polarization conversion element 149 includes a polarization separation layer, a reflection layer, and a retardation film. The polarization separation layer transmits one of linearly polarized components, as it is, of polarization components included in the light from the phosphor wheel 30 while reflecting the other linearly polarized component in a direction perpendicular to the illumination optical axis 100ax. The reflection layer reflects the other linearly polarized component reflected by the polarization separation layer in a direction parallel to the illumination optical axis 100ax. The retardation film converts the other linearly polarized component reflected by the reflection layer to the one linearly polarized component.

The superimposing lens 150 concentrates the partial luminous fluxes from the polarization conversion element 149 and superimposes the partial luminous fluxes on each other in the vicinities of the image forming regions of the liquid crystal light modulators 400R, 400G, and 400B. The first lens array 120, the second lens array 130, and the superimposing lens 150 constitute an integrator optical system that makes an in-plane light intensity distribution of the light from the phosphor wheel 30 uniform.

The color separation and light guide optical system 200 includes dichroic mirrors 210 and 220, reflection mirrors 230, 231, and 232, and relay lenses 260 and 270. The color separation and light guide optical system 200 separates the white light W from the illumination device 100 into red light R, green light G, and the blue light B, and guides the red light R, the green light G, and the blue light B to the liquid crystal light modulators 400R, 400G, and 400B respectively corresponding thereto.

Field lenses 300R, 300G, and 300B are disposed between the color separation and light guide optical system 200 and the liquid crystal light modulators 400R, 400G, and 400B.

The dichroic mirror 210 is a dichroic mirror that transmits a red light component and reflects a green light component and a blue light component.

The dichroic mirror 220 is a dichroic mirror that reflects the green light component and transmits the blue light component.

The reflection mirror 230 is a reflection mirror that reflects the red light component.

The reflection mirrors 231 and 232 are reflection mirrors that reflect the blue light component.

The red light transmitted through the dichroic mirror 210 is reflected by the reflection mirror 230, passes through the field lens 300R, and is incident on the image forming region of the liquid crystal light modulator 400R for red light.

The green light reflected by the dichroic mirror 210 is further reflected by the dichroic mirror 220, passes through the field lens 300G, and is incident on the image forming region of the liquid crystal light modulator 400G for green light.

The blue light transmitted through the dichroic mirror 220 is incident on the image forming region of the liquid crystal light modulator 400B for blue light through the relay lens 260, the reflection mirror 231 on the light incident side, the relay lens 270, the reflection mirror 232 on the light exiting side, and the field lens 300B.

The liquid crystal light modulators 400R, 400G, and 400B modulate, in response to image information, the color lights incident thereon, and form color images corresponding to the respective color lights. Although not shown in the drawing, a light incident-side polarizer is disposed between each of the field lenses 300R, 300G, and 300B and each of the liquid crystal light modulators 400R, 400G, and 400B and a light exiting-side polarizer is disposed between each of the liquid crystal light modulators 400R, 400G, and 400B and the cross dichroic prism 500.

The cross dichroic prism 500 is an optical element that combines the image lights emitted from the liquid crystal light modulators 400R, 400G, and 400B to form a color image.

The cross dichroic prism 500 has a substantially square shape, in a plan view, formed of four right-angle prisms bonded together, and dielectric multilayer films are formed at substantially X-shaped interfaces between the right-angle prisms bonded together.

The color image emitted from the cross dichroic prism 500 is enlarged and projected by the projection optical system 600 to form an image on the screen SCR.

The configuration of the phosphor wheel 30 of the embodiment will be described in detail.

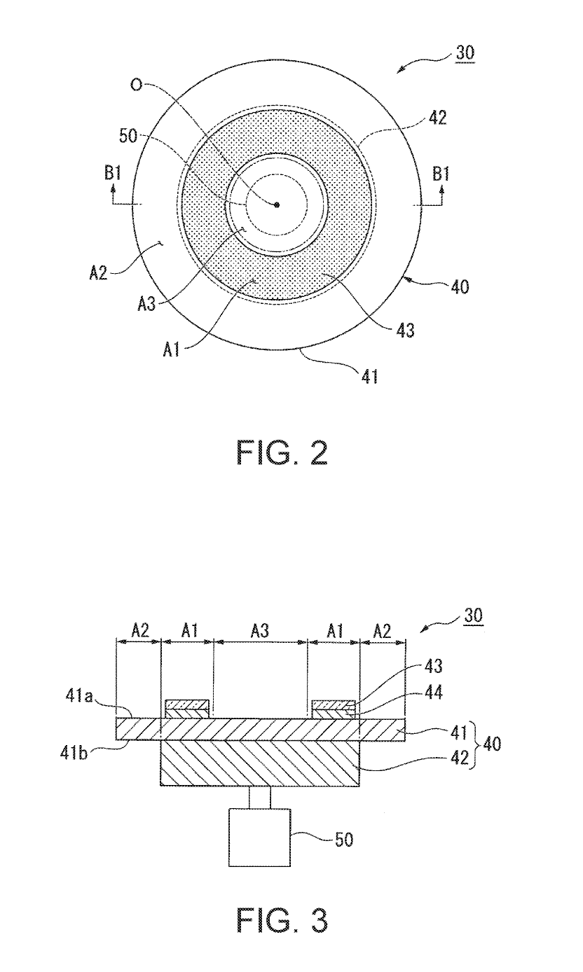

FIG. 2 is an elevation view of the phosphor wheel 30. FIG. 3 is a cross-sectional view taken along line B1-B1 of FIG. 2.

As shown in FIGS. 1 to 3, the phosphor wheel 30 includes a substrate 40 and the phosphor layer 43 supported by the substrate 40. The substrate 40 has a circular plate-like planar shape and is rotatable by the motor 50 around an axis O of rotation. The phosphor layer 43 is provided in a ring shape along the circumferential direction of the substrate 40.

The phosphor layer 43 emits the fluorescence Y through excitation by the excitation light E from the first light source 10. In the embodiment, the excitation light E from the first light source 10 is incident from the side of the phosphor layer 43 opposite to the substrate 40. A reflection film 44 that reflects visible light is provided between the phosphor layer 43 and the substrate 40. The reflection film 44 is formed of, for example, an Ag film.

Based on the configuration described above, the phosphor wheel 30 emits the fluorescence Y toward the side on which the excitation light E is incident.

By the way, when the phosphor layer 43 absorbs the excitation light E and emits light, the phosphor layer 43 experiences heat loss corresponding to a difference between the energy of the absorbed excitation light E and the energy of the fluorescence Y. This heat loss increases the temperature of the phosphor layer 43. The phosphor layer 43 has the property of giving rise to a phenomenon called thermal quenching, in which the conversion efficiency from the excitation light E to the fluorescence Y is reduced when the temperature of the phosphor layer 43 increases.

For keeping high luminous efficiency of the phosphor layer 43, it is necessary to efficiently discharge heat associated with fluorescence emission and reduce the temperature increase of the phosphor layer 43. By using metal having a high thermal conductivity, such as aluminum or copper, as the material of the substrate 40, the temperature increase of the phosphor layer 43 can be reduced.

The phosphor layer 43 contains phosphor particles (not shown) and a binder material (not shown) that holds the phosphor particles. In the embodiment, an inorganic material having a high thermal conductivity is used as the binder material so that the thermal resistance of the phosphor layer 43 is lowered.

Specifically, in the embodiment, the phosphor particle is formed of, for example, a YAG-based phosphor, (Y,Gd)₃(Al,Ga)₅O₁₂:Ce. The binder material is formed of, for example, low-melting-point glass. The ratio between the phosphor particles and the binder material is 50:50. That is, the phosphor layer 43 is formed of a sintered body obtained by firing a YAG-based phosphor with low-melting-point glass used as a support material.

The phosphor layer 43 formed of the sintered body of an inorganic material is excellent in heat-dissipating property and can efficiently produce the fluorescence Y. However, the above-described phosphor layer 43 is highly brittle and therefore may be broken due to a load generated during assembly or thermal stress generated during fluorescence emission.

Here, as shown in FIG. 2, the substrate 40 is virtually divided into three regions (a first region A1, a second region A2, and a third region A3) in a plan view. The second region A2 is located on the outermost circumferential side of the substrate 40. The first region A1 is located closer to the inner circumferential side than the second region A2. The third region A3 is located closer to the inner circumferential side than the first region A1. The phosphor layer 43 is provided in the first region A1.

As shown in FIG. 3, the substrate 40 includes a first portion 41 and a second portion 42. The first portion 41 and the second portion 42 are integrally formed by cutting, for example, an aluminum plate.

The substrate 40 may be formed by bonding together the first portion 41 and the second portion 42 that are formed of different members. For example, when circular plate members that constitute the first portion 41 and the second portion 42 are formed by punching a roll material with a punch press, a warp may occur in the circular plate members. In this case, the substrate 40 may be formed by bonding the circular plate members together so as to cancel out each other's warps.

The first portion 41 has a circular plate-like planar shape, and the reflection film 44 and the phosphor layer 43 are provided on an upper surface 41a of the first portion 41. The reflection film 44 and the phosphor layer 43 are secured to the upper surface 41a through, for example, an adhesive layer.

The second portion 42 has a circular plate-like planar shape and is provided on a lower surface 41b of the first portion 41 opposite the upper surface 41a.

In the embodiment, the outside diameter of the second portion 42 is smaller than the outside diameter of the first portion 41 (see FIG. 2). Specifically, the second portion 42 is provided in a region of the lower surface 41b corresponding to the first region A1 and the third region A3. That is, the first region A1 and the third region A3 are each formed of a portion of the first portion 41 and the second portion 42, and the thicknesses of the first region A1 and the third region A3 are the same as each other. The thickness of the first region A1 and the thickness of the third region A3 are both equal to the sum of the thickness of the first portion 41 and the thickness of the second portion 42.

The second region A2 is formed of the remaining portion of the first portion 41. The thickness of the second region A2 is equal to the thickness of the first portion 41. Therefore, the first region A1 and the third region A3 are thicker than the second region A2.

As described above, the substrate 40 of the embodiment is reinforced against external force such as bending stress by making the first region A1 supporting the phosphor layer 43 and the third region A3 inside the phosphor layer 43 thicker than the second region A2.

In the phosphor wheel 30 including the substrate 40 rotated by the motor 50, the substrate 40 provided with the phosphor layer 43 needs to be attached to the motor 50. At this time, however, the phosphor layer 43 may be broken. Especially in the embodiment, since a material that is highly brittle is used as the phosphor layer 43 as described above, the phosphor layer 43 has a high risk of breakage. Further, since the phosphor layer 43 has a ring shape in the embodiment, the phosphor layer 43 has a higher risk of breakage.

With respect to the risk, since the first region A1 supporting the phosphor layer 43 is reinforced in the embodiment, the substrate 40 is less likely to deform in the first region A1 during attachment work to the motor 50. Further, since the third region A3 is also thicker than the second region A2, the substrate 40 is less likely to deform also on the inner circumferential side of the phosphor layer 43. Hence, trouble such as the breakage of the phosphor layer 43 due to the deformation of the phosphor layer 43 together with the substrate 40 is less likely to occur during attachment work.

Moreover, even when heat that is generated in the phosphor layer 43 by irradiation with the excitation light E is conducted to the substrate 40, the first region A1 is less likely to deform. Therefore, trouble such as the breakage of the phosphor layer 43 due to the deformation of the phosphor layer 43 together with the substrate 40 is less likely to occur also during the operation of the illumination device 100.

Moreover, since the substrate 40 of the embodiment includes, on the outer circumferential side of the first region A1 where the phosphor layer 43 is provided, the second region A2 thinner than the first region A1, heat that is conducted from the phosphor layer 43 to the first region A1 can be efficiently dissipated through the second region A2. Therefore, the temperature increase of the phosphor layer 43 is reduced, so that high luminous efficiency can be obtained in the phosphor layer 43.

Moreover, since the second region A2 is thinner than the first region A1 and the third region A3, the moment of inertia is smaller than that when the thickness of the second region A2 is increased similarly to the thickness of the first region A1.

As described above, since the illumination device 100 of the embodiment includes the phosphor wheel 30 in which the phosphor layer 43 is less likely to break, the illumination device 100 can stably emit light and has high reliability. Moreover, the projector 1 including the illumination device 100 has also high reliability.

### Second Embodiment

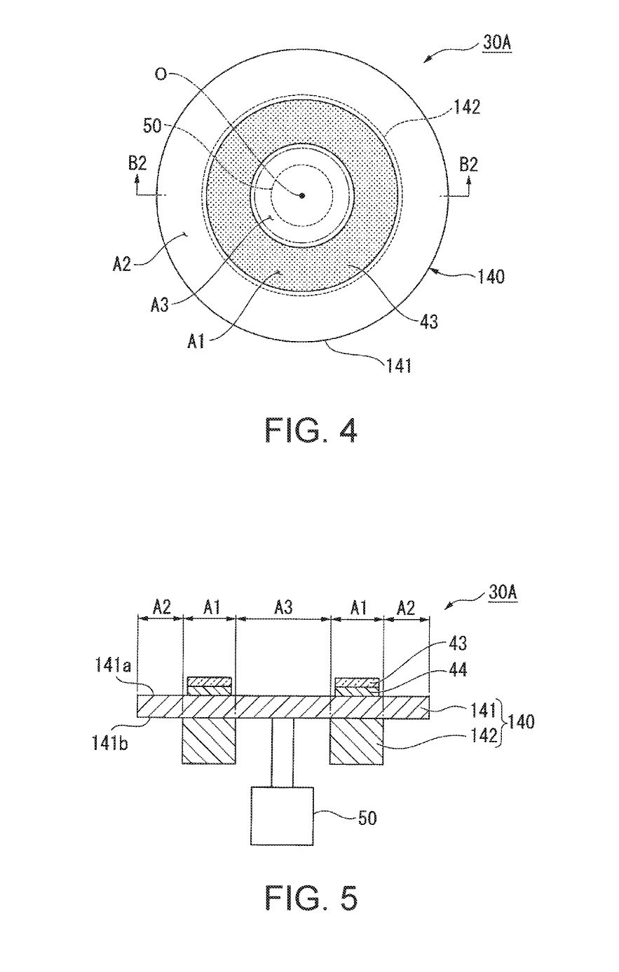

Subsequently, a phosphor wheel according to a second embodiment will be described. FIG. 4 is an elevation view of the phosphor wheel 30A according to the second embodiment. FIG. 5 is a cross-sectional view taken along line B2-B2 of FIG. 4. The same reference numerals and signs are used for the same members as those of the above embodiment, and the detailed description of the same members is omitted.

As shown in FIGS. 4 and 5, the phosphor wheel 30A of the embodiment includes a substrate 140 and the phosphor layer 43 supported by the substrate 140.

In a plan view state, the substrate 140 is virtually divided into three regions (the first region A1, the second region A2, and the third region A3). The second region A2 is located on the outermost circumferential side of the substrate 40. The first region A1 is located closer to the inner circumferential side than the second region A2. The third region A3 is located closer to the inner circumferential side than the first region A1. The phosphor layer 43 is provided in the first region A1.

The substrate 140 includes a first portion 141 and a second portion 142. The substrate 140 may be formed by integrally forming the first portion 141 and the second portion 142, or may be formed by bonding together the first portion 141 and the second portion 142 that are formed of different members.

The first portion 141 has a circular plate-like planar shape, and the reflection film 44 and the phosphor layer 43 are provided on an upper surface 141a of the first portion 141. The second portion 142 is provided on a lower surface 141b of the first portion 141 opposite the upper surface 141a.

In the embodiment, the second portion 142 is provided in a region of the lower surface 141b corresponding to the first region A1. The first region A1 is formed of a portion of the first portion 141 and the second portion 142. In the embodiment, the second portion 142 has a ring shape corresponding to the shape of the phosphor layer 43. The thickness of the first region A1 is equal to the sum of the thickness of the first portion 141 and the thickness of the second portion 142.

The second region A2 is formed of a portion of the first portion 141. The thickness of the second region A2 is equal to the thickness of the first portion 141. Therefore, the first region A1 is thicker than the second region A2.

The third region A3 is formed of a portion of the first portion 141. The thickness of the third region A3 is equal to the thickness of the first portion 141.

As described above, the substrate 140 of the embodiment is reinforced against external force such as bending stress by selectively increasing the thickness of the first region A1 supporting the phosphor layer 43.

According to the embodiment, since the first region A1 of the substrate 140 supporting the phosphor layer 43 is reinforced, the substrate 40 is less likely to deform in the first region A1 and thus it is possible to reduce the possibility of breakage of the phosphor layer 43 due to a load applied during assembly or thermal stress generated during the driving of the first light source device 101.

### Third Embodiment

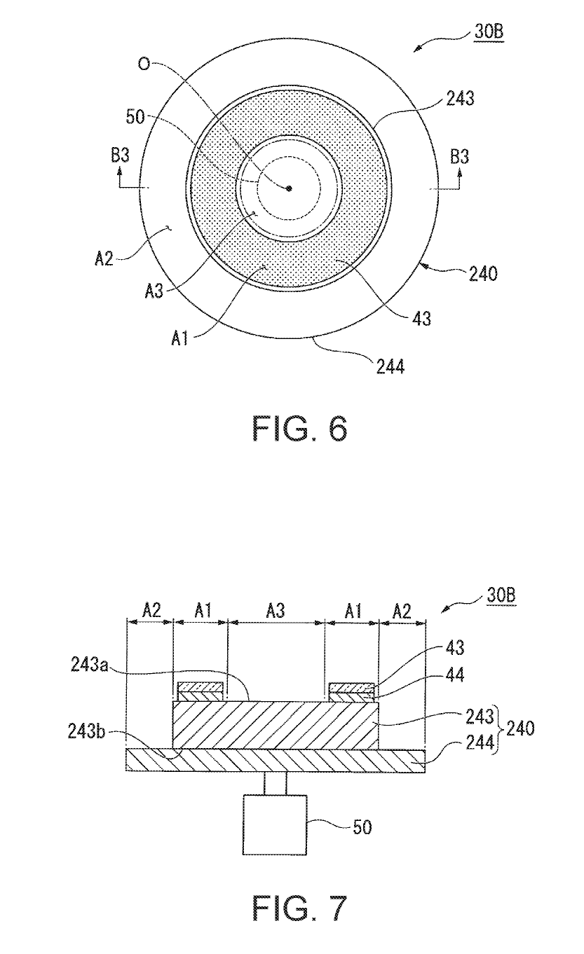

Subsequently, a phosphor wheel according to a third embodiment will be described. FIG. 6 is an elevation view of the phosphor wheel 30B according to the third embodiment. FIG. 7 is a cross-sectional view taken along line B3-B3 of FIG. 6. The same reference numerals and signs are used for the same members as those of the above embodiments, and the detailed description of the same members is omitted.

As shown in FIG. 6, the phosphor wheel 30B of the embodiment includes a substrate 240 and the phosphor layer 43 supported by the substrate 240.

In a plan view state, the substrate 240 is virtually divided into three regions (the first region A1, the second region A2, and the third region A3). The second region A2 is located on the outermost circumferential side of the substrate 240. The first region A1 is located closer to the inner circumferential side than the second region A2. The third region A3 is located closer to the inner circumferential side than the first region A1. The phosphor layer 43 is provided in the first region A1.

As shown in FIG. 7, the substrate 240 includes a third portion 243 and a fourth portion 244. In the embodiment, the substrate 240 is formed by integrally forming the third portion 243 and the fourth portion 244. The substrate 240 may be formed by bonding together the third portion 243 and the fourth portion 244 that are formed of different members.

The third portion 243 has a circular plate-like planar shape, and the reflection film 44 and the phosphor layer 43 are provided on an upper surface 243a of the third portion 243. The fourth portion 244 has a circular plate-like planar shape and is provided on a lower surface 243b of the third portion 243 opposite the upper surface 243a.

In the embodiment, the outside diameter of the fourth portion 244 is larger than the outside diameter of the third portion 243. That is, the first region A1 and the third region A3 are each formed of the third portion 243 and a portion of the fourth portion 244, and the thicknesses of the first region A1 and the third region A3 are the same as each other. The thickness of the first region A1 and the thickness of the third region A3 are both equal to the sum of the thickness of the third portion 243 and the thickness of the fourth portion 244.

The second region A2 is formed of a portion of the fourth portion 244. The thickness of the second region A2 is equal to the thickness of the fourth portion 244. Therefore, the first region A1 and the third region A3 are thicker than the second region A2.

As described above, the substrate 240 of the embodiment is reinforced against external force such as bending stress by making the first region A1 supporting the phosphor layer 43 and the third region A3 inside the phosphor layer 43 thicker than the second region A2.

Also in the phosphor wheel 30B of the embodiment as described above, since the substrate 240 is reinforced by increasing the thicknesses of the first region A1 and the third region A3 of the substrate 240 similarly to the phosphor wheel 30 of the first embodiment, the breakage of the phosphor layer 43 associated with the deformation of the substrate 240 is less likely to occur.

The invention is not necessarily limited to those of the above embodiments, and various modifications can be added within the scope not departing from the gist of the invention.

For example, although the thicknesses of the first region A1 and the third region A3 have been described as being the same as each other in the first and third embodiments, the invention is not limited to this. It is sufficient that the third region A3 has a thickness larger than at least that of the second region A2.

Moreover, although the projector 1 including the three liquid crystal light modulators 400R, 400G, and 400B has been illustrated in the above embodiment, the invention can also be applied to a projector that displays a color video with one liquid crystal light modulator. Moreover, a digital mirror device may be used as a light modulator.

Moreover, although an example in which the light source device according to the invention is mounted in the projector has been shown in the above embodiment, the invention is not limited to this example. The light source device according to the invention can also be applied to a luminaire, an automobile headlight, and the like.

The entire disclosure of Japanese Patent Application No. 2016-033137, filed on Feb. 24, 2016 is expressly incorporated by reference herein.

What is claimed is:

1. A wavelength conversion element comprising:
a substrate rotatable around an axis of rotation; and
a phosphor layer, wherein
the substrate includes a first region on the inner circumferential side of the substrate and a second region provided closer to the outer circumferential side than the first region and thinner than the first region, and
the phosphor layer is provided in the first region.

2. The wavelength conversion element according to claim 1, wherein
the phosphor layer has a ring shape, and
when a region of the substrate located inside the inner circumference of the phosphor layer is defined as a third region, the substrate is thicker in the third region than in the second region.

3. The wavelength conversion element according to claim 1, wherein
the substrate includes a first portion including a first surface and a second surface opposite the first surface, and a second portion,
the phosphor layer is provided on the first surface, and
the second portion is provided in the first region of the second surface.

4. The wavelength conversion element according to claim 1, wherein
the phosphor layer is formed of an inorganic material.

5. The wavelength conversion element according to claim 4, wherein
the phosphor layer is formed of a sintered body containing a phosphor.

6. A light source device comprising:
the wavelength conversion element according to claim 1;
a drive device that rotates the substrate around the axis of rotation; and
a light-emitting element that emits excitation light to be incident on the phosphor layer.

7. A light source device comprising:
the wavelength conversion element according to claim 2;
a drive device that rotates the substrate around the axis of rotation; and
a light-emitting element that emits excitation light to be incident on the phosphor layer.

8. A light source device comprising:
the wavelength conversion element according to claim 3;
a drive device that rotates the substrate around the axis of rotation; and
a light-emitting element that emits excitation light to be incident on the phosphor layer.

9. A light source device comprising:
the wavelength conversion element according to claim 4;
a drive device that rotates the substrate around the axis of rotation; and
a light-emitting element that emits excitation light to be incident on the phosphor layer.

10. A light source device comprising:
the wavelength conversion element according to claim 5;
a drive device that rotates the substrate around the axis of rotation; and
a light-emitting element that emits excitation light to be incident on the phosphor layer.

11. A projector comprising:
the light source device according to claim 6;
a light modulator that modulates, in response to image information, light from the light source device to thereby form image light; and
a projection optical system that projects the image light.

12. A projector comprising:
the light source device according to claim 7;
a light modulator that modulates, in response to image information, light from the light source device to thereby form image light; and
a projection optical system that projects the image light.

13. A projector comprising:
the light source device according to claim 8;
a light modulator that modulates, in response to image information, light from the light source device to thereby form image light; and
a projection optical system that projects the image light.

14. A projector comprising:
the light source device according to claim 9;
a light modulator that modulates, in response to image information, light from the light source device to thereby form image light; and
a projection optical system that projects the image light.

15. A projector comprising:
the light source device according to claim 10;
a light modulator that modulates, in response to image information, light from the light source device to thereby form image light; and
a projection optical system that projects the image light.
